(19) United States
(12) Patent Application Publication
(10) Pub. No.: US 2005/0277505 A1
(43) Pub. Date: Dec. 15, 2005

(54) Single arm idler belt tensioning assembly

(76) Inventors: Chong B. Wong, Vernon Hills, IL (US); Robert Dam, Aurora, IL (US); John G. Drelicharz, Palatine, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/063,016

(22) Filed: Feb. 22, 2005

Related U.S. Application Data
(60) Provisional application No. 60/579,461, filed on Jun. 14, 2004.

(51) Int. Cl. F16H 7/08; F16H 7/18

(52) U.S. Cl. 474/111; 474/140

(57) ABSTRACT

An idler arm and belt tensioner defines a low-function trough biased against a drive belt in a belt drive system. An anchor end of the tensioning arm is secured by a bracket to a fixed body. The bracket defines a lip disposed in a slot of the fixed body so that only a single fastener is required to secure the anchor bracket to the fixed body.

### CROSS-REFERENCE TO RELATED APPLICATIONS

The present regular United States patent application claims the benefits of U.S. Provisional Patent Application Ser. No. 60/579,461 filed Jun. 14, 2004.

### FIELD OF THE INVENTION

The present invention relates generally to idler or tensioning assemblies on belt drives and, more particularly, to idler or belt tensioning assemblies commonly used in appliance drives such as found in clothes dryers.

### BACKGROUND OF THE INVENTION

Belt drives are commonly used in many devices and appliances to convey power from a motor to a portion of the appliance to be driven. For example, belt drives are commonly used in clothes dryers to rotate the dryer drum for tumbling the clothes while drying. A known configuration for such drive systems utilizes a belt wrapped around the dryer drum and a drive motor. The drum is thereby driven directly by the motor without the need for intervening speed reducers or the like since the dryer drum is of significantly greater diameter than the drive pulley on the motor.

It is known to provide an idler roller biased against the belt between the dryer drum and the drive pulley on the motor. The idler roller is attached to a pivot arm or L-bracket. On end of the L-bracket is connected at a pivot point, and the other end of the L-bracket is connected to one end of a spring. An opposite end of the spring is connected to a fixed bracket. The spring thereby biases the arm toward the belt causing the idler roller on the arm to exert tensioning force against the belt. As the belt is caused to move by the drive roller, the belt moves over the idler roller. The spring force and the belt force work against each other; however, because of the mechanical arrangement, the tensioner system ensures that the belt is under sufficient tension to cause the drum to move as desired.

While such known drive and tensioning systems have proven satisfactory in many situations, because of the significant number of parts and the types of parts involved in such systems, the system is generally costly to make, assemble and install. The L-bracket must be pivotally connected to its anchor location, the idling roller must be mounted on the L-bracket, and the spring must be connected to both the L-bracket and to the spring anchor point. Performing all these separate steps adds significant time to the assembly process for manufacturing dryers. In addition, it is known to pack the idler roller in grease, which adds further cost to the overall design. The continuous rolling idler wheel is subject to wear and failure, as is the L-bracket pivotal connection. The spring also can fail at the connection point or elsewhere. Further, a problem has arisen with some known prior designs in that over time and with use the idler roller tends to squeak during operation. The squeaking sound while the dryer operates is unpleasant to users of the dryer.

What is needed in the art is a simplified belt tensioner that has fewer parts than known designs, is easy to install and remains reliable in use for an extended period of time.

### SUMMARY OF THE INVENTION

The present invention provides a spring arm anchored to a fixed support in the appliance, with a curved low-friction surface biased against the belt to provide tensioning force on the belt.

In one aspect thereof, the present invention provides a belt tensioner, with a spring arm having an anchor end and a curved end. The curved end defines a belt track. An anchor bracket is connected to the anchor end. The anchor bracket has a lip at an edge thereof and is configured for attachment by way of a fastener.

In another aspect thereof, the present invention provides a belt-drive system with a driven object, a drive object and a drive belt engaged to the driven object and the drive object. A fixed body defines a slot. A spring arm has an anchor end and a curved end. The curved end defines a belt track biased against the drive belt. An anchor bracket is affixed to the fixed body and to the anchor end, and the anchor bracket has a lip disposed in the slot defined by the fixed body.

In a still further aspect thereof, the present invention provides a belt tensioning system with a spring arm having an anchor end and a curved end. The curved end defines a belt track. An anchor bracket is connected to the anchor end. A fastener connects the anchor bracket to a mounting bracket. A first positioning part is associated with the anchor bracket, and a second positioning part is associated with the mounting bracket. The first and second positioning parts are configured to engage one with the other to limit relative rotation between the anchor bracket and the mounting bracket.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a fragmentary elevational view of a clothes dryer illustrating the drive system of the present invention;

FIG. 2 is a perspective view of a tensioning idler arm in accordance with the present invention;

FIG. 3 is an elevational view of the idler arm shown in FIG. 2;

FIG. 4 is an elevational view from another perspective of the arm shown in the previous drawings; and

FIG. 5 is a fragmentary view of a portion of the mounting bracket to which the idler arm is connected.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

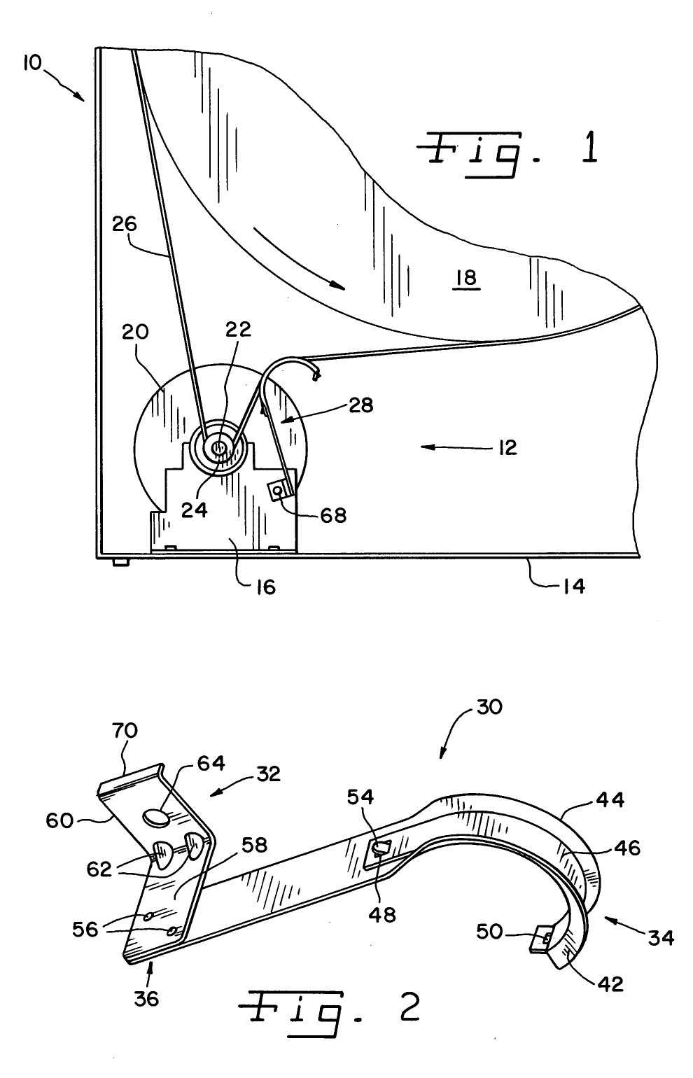

Referring now more specifically to the drawings and to FIG. 1 in particular, numeral 10 designates a clothes dryer having a drive system 12 in accordance with the present invention. It should be understood that drive system 12 has particular advantage when used on a clothes dryer; however, drive system 12 of the present invention can be used on other belt drive systems, including belt drives on other appliances as well as on other things.

Dryer 10 generally includes an outer frame or body 14, various mounting brackets 16 anchored to body 14 to support and hold the components of the dryer. A drum 18 is rotatably held within body 14 and rotates to tumble the clothes placed therein for drying. Dryer 10 also includes a variety of other components including heating elements for supplying heated air to drum 18, various controls and components not shown.

Drive system 12 includes a motor 20 held by bracket 16 and having a motor shaft 22 with a drive pulley 24 thereon. A drive belt 26 is engaged with drum 18 as the driven object and with drive pulley 24 as the drive object within drive system 12. Thus, rotation of drive pulley 24 by motor shaft 22 causes movement of drive belt 26 and corresponding rotation of dryer drum 18. It should be understood that the present invention is applicable also to drive systems in which drive belt 26 is entrained about a pulley of the driven object in the drive system, and need not necessarily be entrained about the object directly.

To ensure adequate tension in drive belt 26 such that the drive belt is rotated by drive pulley 24 and rotates dryer drum 18 without slipping, a belt tensioning assembly 28 is provided. Belt tensioning system 28 includes a spring arm 30 connected to mounting bracket 16 by an anchor bracket 32. While shown to be connected to the same mounting bracket 16 as motor 20, spring arm 30 can also be connected to another mounting bracket 16 or fixed body component of dryer 10.

Spring arm 30 is an elongated body of metal or other springing material and has a curved end 34 and an anchor end 36. Curved end 34 defines a belt track 38 having a bottom 40 and opposite sides 42, 44 thereby defining a trough-like structure for guiding belt 26 across curved end 34. The size of trough-like track 38, in both width and depth, is selected to accommodate the width, thickness and cross-sectional shape of drive belt 26.

A wear layer 46 of low-friction material with high wear characteristics, such as Teflon is provided on bottom 40 through belt track 38, to guide belt 26 with minimal resistance and with minimal wear to either belt 26 or to curved end 34. Layer 46 can be secured to curved end 34 by a variety of suitable means, including adhesive, fasteners or the like. The drawings illustrate one advantageous structure in which holes 48 and 50 on the opposite ends of layer 46 receive tabs 52, 54 formed in spring arm 30 to secure layer 46 in position.

Anchor end 36 of spring arm 30 is secured to anchor bracket 32 by suitable means, which may include one or more rivets 56, welding, adhesive or other suitable fixing means. Alternatively, spring arm 30 and anchor bracket 32 can be a single, monolithic body formed or stamped from a single piece of material.

Anchor bracket 32 is a substantially L-shaped bracket having a first side 58 connected to anchor end 36 and a second side 60 by which anchor bracket 32 is connected to mounting bracket 16. One or more gusset 62 can be provided to improve rigidity between first side 58 and second side 60. Since spring arm 30 preferably is a serviceable part, the connection between anchor bracket 32 and mounting bracket 16 must be secure but preferably detachable. In the exemplary embodiment illustrated, second side 60 defines a hole 64 through which a fastener such as a bolt, screw or the like can be used to connect anchor bracket 32 to mounting bracket 16. Mounting bracket 16 can define a corresponding hole 68 to receive a fastener in the nature of a bolt, or to threadedly engage the fastener in the nature of a screw. In still other configurations, either hole 64 of anchor bracket 32 or hole 68 of mounting bracket 16 can be provided to accommodate a fastener in the nature of a fixed, threaded stud extending from the other of mounting bracket 16 or anchor bracket 32.

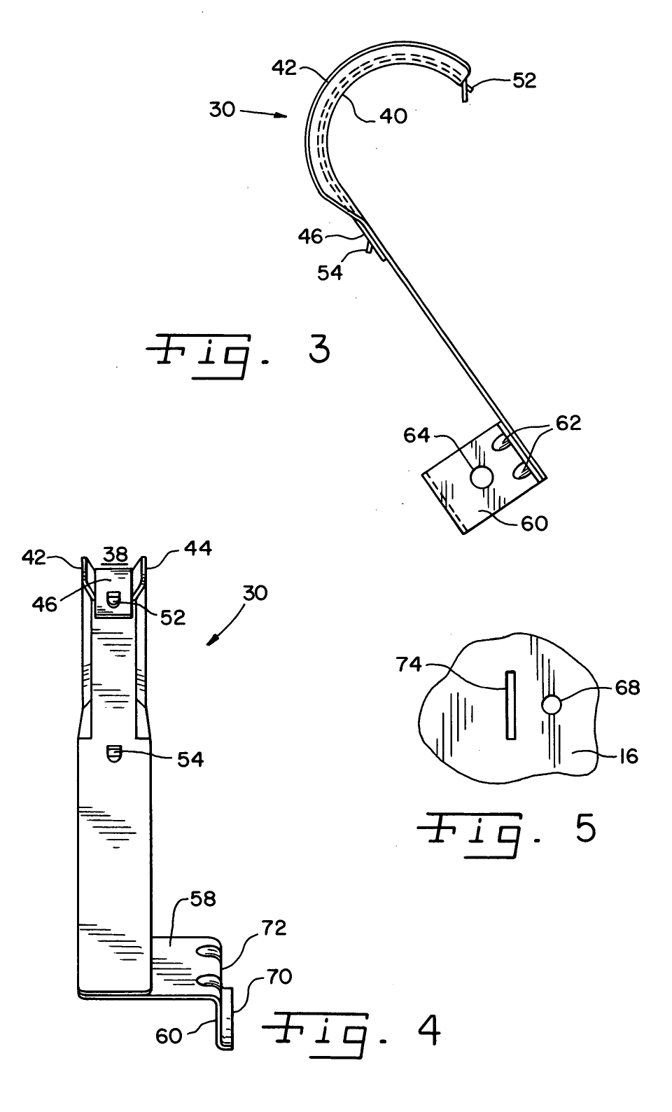

To ensure proper, secure positioning of anchor bracket 32 and thus spring arm 30, multiple fasteners can be used. However, the use of multiple fasteners complicates assembly, lengthens assembly time and increases the number of parts required. An advantageous structure is illustrated in FIGS. 2-5 by which a first positioning part in the way of a projection such as a lip 70 is provided on anchor bracket 32, such as along an outer edge of second side 60. Projection or lip 70 extends past a face 72 of second side 60 that confronts mounting bracket 16. Mounting bracket 16 defines a second positioning part in the way of an opening such as a slot 74 for receiving lip 70, thereby positioning spring arm 30 at a proper angle to belt 26 and preventing rotation of anchor bracket 32 relative to mounting bracket 16. With lip 70 disposed in slot 74, as long as the fastener connecting anchor bracket 32 to mounting bracket 16 remains tight anchor bracket 32 can not rotate about the axis formed by fastener. It should be understood that the relative locations of lip 70 and slot 74 can be reversed, with slot 74 provided in anchor bracket 32, and lip 70 or other projection provided on mounting bracket 16. Further, instead of a single elongated lip 70 and slot 74, multiple pin-like projections and openings can be used to prevent rotation of anchor bracket 32 relative to mounting bracket 16.

In use, belt tensioning assembly 28 is easily attached in proper position by inserting lip 70 in slot 74 and securing the fastener between mounting bracket 16 and anchor bracket 32. With spring arm 30 provided of proper length and curvature and at the proper angular position, a pre-selected tensioning force is exerted on drive belt 26 for driving dryer drum 18 via drive pulley 24 of motor 20. Since only a single fastener need be secured, assembly is both quick and easy. The simplified arrangement minimizes potential failure from wear over time.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A belt tensioner, comprising:
a spring arm having an anchor end and a curved end, said curved end defining a belt track for engaging a drive belt; and
an anchor bracket connected to said anchor end, said anchor bracket having a lip at an edge thereof and being configured for attachment by way of a fastener.

2. The belt tensioner of claim 1, said arm and said bracket being a monolithic body.

3. The belt tensioner of claim 1, said belt track having a bottom and sides defining a trough.

4. The belt tensioner of claim 3, said bottom having a wear layer disposed thereon.

5. The belt tensioner of claim 4, said anchor bracket defining a hole for receiving a fastener.

6. The belt tensioner of claim 5, said arm and said bracket being a monolithic body.

7. The belt tensioner of claim 1, said anchor bracket defining a hole for receiving a fastener.

8. A belt-drive system comprising:
a driven object;
a drive object;
a drive belt engaged to said driven object and said drive object;
a fixed body defining a slot;
a spring arm having an anchor end and a curved end, said curved end defining a belt track biased against said drive belt; and
an anchor bracket affixed to said fixed body and to said anchor end, said anchor bracket having a lip disposed in said slot defined by said fixed body.

9. The belt-drive system of claim 8, said driven object being a clothes dryer drum.

10. The belt-drive system of claim 8, said anchor bracket and said fixed body each defining a hole for receiving a fastener, and a fastener disposed in said holes and affixing said anchor bracket to said fixed body.

11. The belt-drive system of claim 10, said anchor bracket and said fixed body each defining only one said hole, and only one said fastener disposed in said holes and affixing said anchor bracket to said fixed body.

12. The belt-drive system of claim 11, said driven object being a clothes dryer drum.

13. The belt-drive system of claim 8, said belt track having a bottom and sides defining a trough.

14. The belt-drive system of claim 13, said bottom having a wear layer disposed thereon.

15. The belt-drive system of claim 8, said spring arm and said anchor bracket being a monolithic body.

16. A belt tensioning system comprising:
a spring arm having an anchor end and a curved end, said curved end defining a belt track;
an anchor bracket connected to said anchor end;
a mounting bracket;
a fastener connecting said anchor bracket to said mounting bracket;
a first positioning part associated with said anchor bracket;
a second positioning part associated with said mounting bracket; and
said first and second positioning parts being configured to engage one with the other to limit relative rotation between said anchor bracket and said mounting bracket.

17. The belt tensioning system of claim 16, one of said first and second positioning parts being a projection and the other of said first and second positioning parts being an opening for receiving said projection.

18. The belt tensioning system of claim 17, said projection being an elongated lip and said opening being a slot.

19. The belt tensioning system of claim 18, said lip extending from an edge of said anchor bracket.

20. The belt tensioning system of claim 19 including only one said fastener.
